(19) United States
(12) Patent Application Publication
(10) Pub. No.: US 2019/0061164 A1
(43) Pub. Date: Feb. 28, 2019

(54) INTERACTIVE ROBOT

(71) Applicants: Fu Tai Hua Industry (Shenzhen) Co., Ltd., Shenzhen (CN); HON HAI PRECISION INDUSTRY CO., LTD., New Taipei (TW)

(72) Inventors: Zhaohui Zhou, Santa Clara, CA (US); Neng-De Xiang, Shenzhen (CN); Xue-Qin Zhang, Shenzhen (CN)

(21) Appl. No.: 15/817,037

(22) Filed: Nov. 17, 2017

(30) Foreign Application Priority Data
Aug. 28, 2017 (CN) 201710752403.5

(51) Int. Cl. B25J 11/00; B25J 19/02; B25J 5/00

(52) U.S. Cl. CPC B25J 11/0015; B25J 5/007; B25J 19/026; B25J 11/0005

(57) ABSTRACT

An interactive robot includes an input module having at least one input element, an output module having at least one output element, a communication unit in communication with a server, a storage unit, and at least one processor. The processor establishes at least one of the at least one input elements as a standby input element and establishes at least one of the at least one output element as a standby output element, obtains input information from the at least one standby input element, analyzes the input information and generates a control command according to the input information, and executes the control command through the at least one standby output element.

### CROSS-REFERENCE TO RELATED APPLICATIONS

This application claims priority to Chinese Patent Application No. 201710752403.5 filed on Aug. 28, 2017, the contents of which are incorporated by reference herein.

### FIELD

The subject matter herein generally relates to an interactive robot.

### BACKGROUND

Interactive robots are currently limited in the ways they can interact with people.

### BRIEF DESCRIPTION OF THE DRAWINGS

Implementations of the present disclosure will now be described, by way of example only, with reference to the attached figures.

FIG. 1 is a diagram of an exemplary embodiment of an interactive robot.

FIG. 2 is another diagram of the interactive robot of FIG. 1.

FIG. 3 is a diagram of function modules of an interactive system of the interactive robot.

FIG. 4 is a diagram of an interface of the interactive robot.

FIG. 5 is a diagram of an example first relationship table stored in the interactive robot.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage unit.

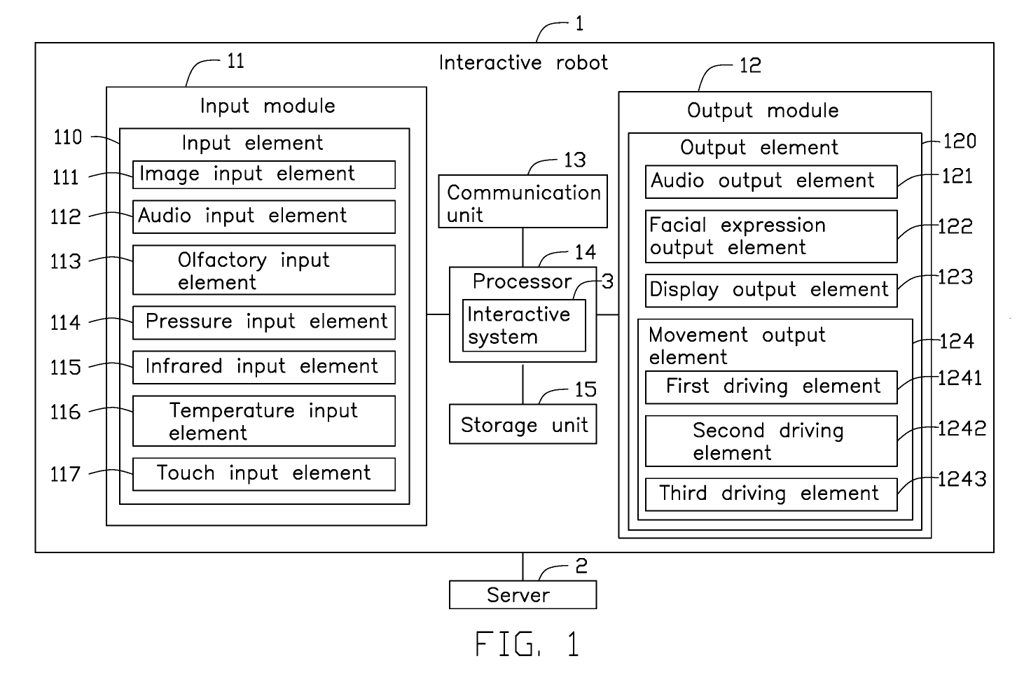

FIG. 1 illustrates an embodiment of an interactive robot 1. The interactive robot 1 can include an input module 11, an output module 12, a communication unit 13, a processor 14, and a storage unit 15. The input module 11 can include a plurality of input elements 110, and the output module 12 can include a plurality of output elements 120. The interactive robot 1 can communicate with a server 2 through the communication unit 13. The processor 14 can implement an interactive system 3. The interactive system 3 can establish a standby input element of the input elements 110 and establish a standby output element of the output elements 120. The interactive system 3 can obtain input information from the standby input element or from the server 2, process the input information, and control the interactive robot 1 to output a response.

The input module 11 can include, but is not limited to, an image input element 111, an audio input element 112, an olfactory input element 113, a pressure input element 114, an infrared input element 115, a temperature input element 116, and a touch input element 117.

The image input element 111 is used for capturing images from around the interactive robot 1. For example, the image input element 111 can capture images of a person or an object. In at least one embodiment, the image input element 111 can be a camera.

The audio input element 112 is used for capturing audio from around the interactive robot 1. In at least one embodiment, the audio input element 112 can be a microphone array.

The olfactory input element 113 is used for capturing smells from around the interactive robot 1.

The pressure input element 114 is used for detecting an external pressure on the interactive robot 1.

The infrared input element 115 is used for detecting heat signatures of people around the interactive robot 1.

The temperature input element 116 is used for detecting a temperature around the interactive robot 1.

The touch input element 117 is used for receiving touch input from a user. In at least one embodiment, the touch input element 117 can be a touch screen.

The output module 12 can include, but is not limited to, an audio output element 121, a facial expression output element 122, a display output element 123, and a movement output element 124.

The audio output element 121 is used for outputting audio. In at least one embodiment, the audio output element 121 can be a loudspeaker.

The facial expression output element 122 is used for outputting a facial expression. In at least one embodiment, the facial expression output element 122 can include eyes, eyelids, and a mouth of the interactive robot 1.

The display output element 123 is used for outputting text, images, or videos. In other embodiments, the display output element 123 can display a facial expression. In other embodiments, the touch input element 117 and the display output element 123 can be the same display screen.

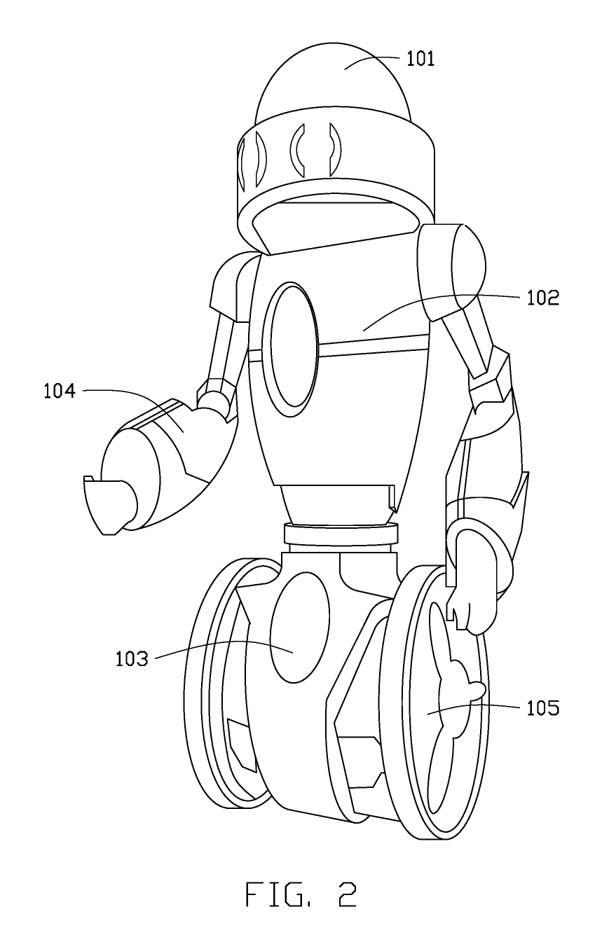

The movement output element 124 is used for moving the interactive robot 1. The movement output element 124 can include a first driving element 1241, two second driving elements 1242, and a third driving element 1243. Referring to FIG. 2, the interactive robot 1 can include a head 101, an upper body 102, a lower body 103, a pair of arms 104, and a pair of wheels 105. The upper body 102 is coupled to the head 101 and the lower body 103. The pair of arms 104 is coupled to the upper body 102. The pair of wheels 105 is coupled to the lower body 103. The first driving element 1241 is coupled to the head 101 and is used for rotating the head 101. Each second driving element 1242 is coupled to a corresponding one of the arms 104 and used for rotating the arm 104. The third driving element 1243 is coupled between the pair of wheels 105 and used for rotating the wheels 105 to cause the interactive robot 1 to move.

The communication unit 13 is used for providing communication between the interactive robot 1 and the server 2. In at least one embodiment, the communication unit 13 can use WIFI, ZIGBEE, BLUETOOTH, or other wireless communication method.

The storage unit 15 can store a plurality of instructions of the interactive system 3, and the interactive system 3 can be executed by the processor 14. In another embodiment, the interactive system 3 can be embedded in the processor 14. The image acquisition system 100 can be divided into a plurality of modules, which can include one or more software programs in the form of computerized codes stored in the storage unit 15. The computerized codes can include instructions executed by the processor 14 to provide functions for the modules. The storage device 20 can be a read-only memory, random access memory, or an external storage device such as a magnetic disk, a hard disk, a smart media card, a secure digital card, a flash card, or the like.

The processor 14 can be a central processing unit, a microprocessing unit, or other data processing chip.

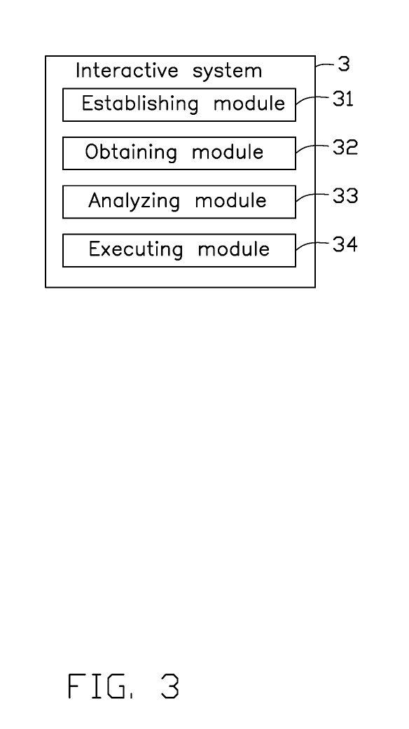

Referring to FIG. 3, the interactive system 3 can include an establishing module 31, an obtaining module 32, an analyzing module 33, and an executing module 34.

The establishing module 31 can establish at least one standby input element of the input module 11 and establish at least one standby output element of the output module 12.

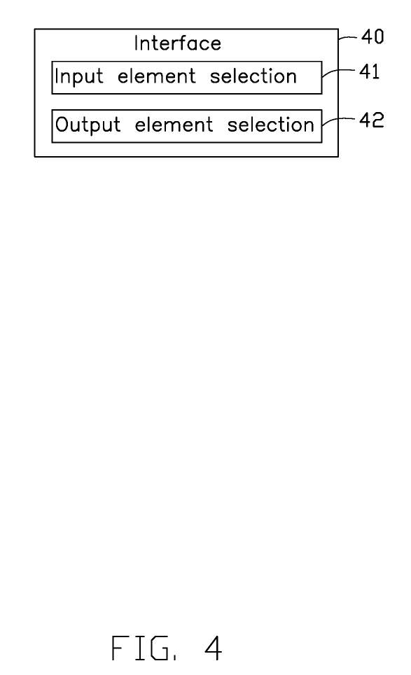

In at least one embodiment, the establishing module 31 provides an interface 40 (shown in FIG. 4) including a plurality of input element selections 41 and a plurality of output element selections 42. Each of the input element selections 41 corresponds to one of the input elements 110, and each of the output element selections 42 corresponds to one of the output elements 120. The establishing module 31 establishes the at least one input element 110 selected on the interface 40 as the standby input element and establishes the at least one output element 120 selected on the interface as the standby output element.

The obtaining module 32 can obtain input information from the at least one standby input element. For example, when the image input element 111 is established as the standby input element, the obtaining module 32 can obtain images captured by the image input element 111. When the audio input element 112 is established as the standby input element, the obtaining module 32 can obtain audio input from the audio input element 112.

The analyzing module 33 can analyze the input information obtained by the obtaining module 32 and generate a control command according to the input information.

The executing module 34 can execute the control command to generate an output and output the output through the at least one standby output element.

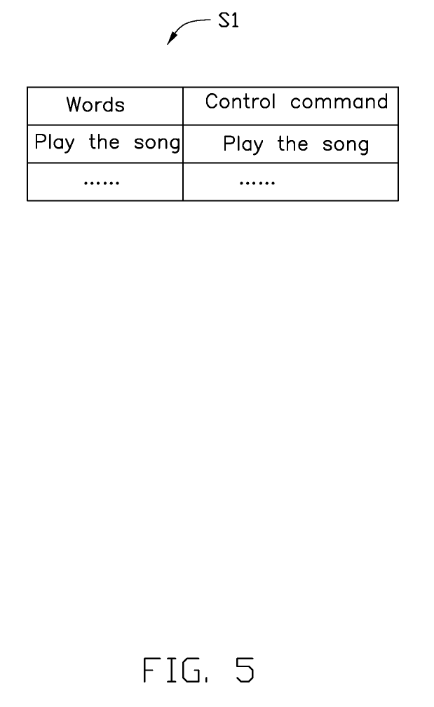

In at least one embodiment, the audio input element 112 is established as the standby input element and the display output element 123 is established as the standby output element. The obtaining module 32 obtains the input information in the form of audio input, and the analyzing module 33 analyzes the audio input to recognize words to generate the control command according to the audio input. In at least one embodiment, the storage unit 15 stores a first relationship table S1 (shown in FIG. 5). The first relationship table S1 can include the words “play the TV show” and the control command “play the TV show”. When the words “play the TV show” are recognized by the analyzing module 33, the analyzing module 33 generates the control command “play the TV show” according to the first relationship table S1. The executing module 34 executes the control command by controlling the display output element 123 to display the TV show. In detail, the executing module 34 controls the interactive robot 1 to search the server 2 according to the audio input for the TV show and controls the display output element 123 to display the TV show.

In at least one embodiment, the audio input element 112 is established as the standby input element, and the audio output element 121 is established as the standby output element. The obtaining module 32 obtains the input information in the form of audio input, and the analyzing module 33 analyzes the audio input to recognize words to generate the control command according to the audio input. The first relationship table S1 can include the words “play the song . . . ” and the control command “play the song . . . ”. When the words “play the song . . . ” are recognized by the analyzing module 33, the analyzing module 33 generates the control command “play the song . . . ” according to the first relationship table S1. For example, the storage unit 15 can store a plurality of songs, and the analyzing module 33 can determine the song mentioned in the words of the input information. The executing module 34 executes the control command by controlling the audio output element 121 to play the corresponding song. In detail, the executing module 34 opens a stored music library (not shown) and searches for the song according to the audio input and controls the audio output element 121 to play the song.

In at least one embodiment, the audio input element 112 and the image input element 111 are established as the standby input elements, and the audio output element 121, the facial expression output element 122, the display output element 123, and the movement output element 124 are established as the standby output elements. The obtaining module 32 obtains the input information from the audio input element 112 and the image input element 111. The analyzing module 33 analyzes the input information to recognize a target. In at least one embodiment, the analyzing module 33 recognizes the target according to voiceprint characteristics and facial features of the target. The target can be a person or an animal. In at least one embodiment, the storage unit 15 stores a second relationship table (not shown). The second relationship table defines a preset relationship among the target and the recognized voiceprint characteristics and facial features.

The analyzing module 33 analyzes the input information from the audio input element 112 and the image input element 111 to obtain key information. In detail, the key information of the input information from the audio input element 112 is obtained by converting the input information from the audio input element 112 into text data. The key information of the input information from the image input element 111 is obtained by determining facial expression parameters and limb movement parameters.

The analyzing module 33 searches a preset public knowledge library according to the key information and uses a deep learning algorithm on the public knowledge library to determine a response. The response is a control command for controlling the standby output elements. For example, the audio output element 121 is controlled to output an audio response, the facial expression output element 122 is controlled to output a facial expression response, the display output element 123 is controlled to output a display response, and the movement output element 124 is controlled to output a movement response. In such a way, the interactive robot 1 can interact with the target.

In at least one embodiment, the public knowledge library can include information related to, but not limited to, human ethics, laws and regulations, moral sentiment, religion, astronomy, and geography. The public knowledge library can be stored in the storage unit 15. In other embodiments, the public knowledge library can be stored in the server 2. In at least one embodiment, the deep learning algorithm can include, but is not limited to, a neuro-bag model, a recurrent neural network, and a convolutional neural network.

The executing module 34 executes the control commands for controlling the corresponding standby output elements. The executing module 34 controls the audio output element 121 to output audio and the facial expression output element 122 to display a facial expression. For example, if a user smiles toward the interactive robot 1 and says, “these flowers are beautiful!”, the analyzing module 33 can identify the user as the target and determine the key information of the words to be “flowers”, “beautiful”, determine the key information of the images to be “smile”, search the public knowledge library according to the key information, and use the deep learning algorithm on the public knowledge library to determine the response. The response can control the audio output element 121 to output “These flowers are really beautiful, I also like them!” and control the facial expression output element 122 to display a smiling face by controlling the eyelids, eyes, and mouth.

In another embodiment, the executing module 34 can control the movement output element 124 to control the interactive robot 1 to move and control the display output element 123 to display a facial expression. For example, when the user smiles at the interactive robot 1 and says, “these flowers are really pretty!”, the executing module 34 can control the first driving element 1241 of the movement output element 124 to rotate the head 101 360 degrees, control the third driving element 1243 to drive the wheels 105 to rotate the interactive robot 1 in a circle, and control the display output element 123 to output a preset facial expression.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An interactive robot comprising:
an input module comprising at least one input element;
an output module comprising at least one output element;
a communication unit in communication with a server;
a storage unit; and
at least one processor, wherein the storage unit stores one or more programs, when executed by the at least one processor, the one or more programs cause the at least one processor to:
establish at least one of the at least one input elements as a standby input element and establish at least one of the at least one output element as a standby output element;
obtain input information from the at least one standby input element;
analyze the input information and generate a control command according to the input information; and
execute the control command through the at least one standby output element.

2. The interactive robot of claim 1, wherein the processor establishes the at least one standby input element and the at least one standby output element by:
providing an interface comprising a plurality of input element selections and a plurality of output element selections wherein each of the plurality of input element selections corresponds to one of the at least one input elements and each of the plurality of output element selections corresponds to one of the at least one output elements;
establishing the at least one standby input element according to the input element selection selected on the interface; and
establishing the at least one standby output element according to the output element selection selected on the interface.

3. The interactive robot of claim 1, wherein the at least one input element comprises an audio input element and an image input element; the output module comprises an audio output element, an expression output element, a display output element, and a movement output element.

4. The interactive robot of claim 3, wherein the storage unit stores a first relationship table; the first relationship table stores preset input information and corresponding control information; the processor analyzes the input information to determine the corresponding control information according to the first relationship table.

5. The interactive robot of claim 4, wherein the processor establishes the audio input element as the standby input element and establishes the display output element as the standby output element; the processor obtains input information from the audio input element; the processor analyzes the input information to generate the control command according to the first relationship table; the control command controls the display output element to output a display response according to the input information from the audio input element.

6. The interactive robot of claim 4, wherein the processor establishes the audio input element as the standby input element and establishes the audio output element as the standby output element; the processor obtains input information from the audio input element; the processor analyzes the input information to generate the control command according to the first relationship table; the control command controls the audio output element to output audio according to the input information from the audio input element.

7. The interactive robot of claim 3, wherein the processor establishes the audio input element and the image input element as the standby input elements and establishes the audio output element, the expression output element, the display output element, and the movement output element as the standby output elements; the processor separately obtains the input information from the audio input element and the image input element; the processor analyzes the input information to recognize a target; the processor obtains key information from the input information; the processor searches a public knowledge library according to the key information; the processor uses a deep learning algorithm on the public knowledge library to determine a response; the response is a control command for all of the standby output elements; the audio output element is controlled to output an audio response; the facial expression output element is controlled to output a facial expression response; the display output element is controlled to output a display response; the movement output element is controlled to output a movement response.

8. The interactive robot of claim 7, wherein the input information of the audio input element is converted into text data; the key information of the input information of the audio input element is obtained from the text data.

9. The interactive robot of claim 8, wherein the input information of the image input element comprises a facial expression of the target; the facial expression of the target is analyzed to obtain facial expression parameters; the key information of the input information of the image input element is obtained from the facial expression parameters.

10. The interactive robot of claim 9 comprising:
an upper body;
a head attached to the upper body wherein the head comprises the facial expression output element;
a pair of arms attached to either side of the upper body;
a lower body attached to the upper body;
a pair of wheels attached on either side of the lower body.
